(19) United States
(12) Patent Application Publication
(10) Pub. No.: US 2026/0326838 A1
(43) Pub. Date: Oct. 22, 2026

(54) Modular Aerodynamic Panels For A Vehicle

(71) Applicant: FCA US LLC, Auburn Hills, MI (US)

(72) Inventors: Arturo GUZMAN-MAGANA, Auburn Hills, MI (US); Michael C. GILLAM, Auburn Hills, MI (US); Brian H. NIELANDER, Auburn Hills, MI (US); Deyan NINOV, Auburn Hills, MI (US); Tracy L. SCHMIDT, Auburn Hills, MI (US); Khaled SBEIH, Auburn Hills, MI (US); Gary MARSHALL, Auburn Hills, MI (US)

(21) Appl. No.: 19/180,782

(22) Filed: Apr. 16, 2025

(51) Int. Cl. B62D 35/00

(52) U.S. Cl. CPC B62D 35/007

(57) ABSTRACT

A vehicle includes a first rear pillar, a second rear pillar, a first winglet removably coupled to the first rear pillar and a second winglet removably coupled to the second rear pillar. A wing has a first end coupled to the first winglet and a second end coupled to the second winglet.

### FIELD

The present disclosure relates to a panels for a vehicle, and, more specifically, to modular support panels for changing the look and aerodynamics of a vehicle.

### BACKGROUND

This section provides background information related to the present disclosure which is not necessarily prior art.

Combining styling and performance is an important factor in vehicle design. In many vehicle designs, after market components are added to customize the look of the vehicle. The functionality of the vehicle may also be increased by adding spoilers and the like to the rear of the vehicle. Various products are available for customization of vehicles to provide both functionality and appearance.

### SUMMARY

This section provides a general summary of the disclosure and is not a comprehensive disclosure of its full scope or all of its features.

The present system provides modular panels that allow the vehicle operator to modify the aerodynamics and look of the vehicle.

In one aspect of the disclosure, a vehicle includes a first rear pillar, a second rear pillar, a first winglet removably coupled to the first rear pillar and a second winglet removably coupled to the second rear pillar. A wing has a first end coupled to the first winglet and a second end coupled to the second winglet.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1A is a perspective view of the vehicle having the modular components mounted thereto.

FIG. 1B is a cross-sectional view of the vehicle having the components installed thereon.

FIG. 1C is an exploded view of the vehicle having the modular components in an exploded position.

FIG. 2A is a perspective view of the vehicle having the panel removed.

FIG. 2B is a cross-sectional view of the vehicle having the panel removed.

FIG. 3 is a perspective view of the vehicle having the panel and the appliqués removed.

FIG. 4A is a perspective view of the vehicle having only the winglets installed.

FIG. 4B is a cross-sectional view of the vehicle having the airflow thereover.

FIG. 5 is a perspective view of the vehicle with all the panels removed.

FIG. 6A is a perspective view of vehicle with the wing in an upward position.

FIG. 6B is a perspective view of the vehicle having the wing in a downward position.

FIG. 6C is a perspective view of the wing having motors within the winglets and a control system therefor.

FIG. 7A is a cross-sectional view of a first example of a connector.

FIG. 7B is a perspective view of the connector of FIG. 7A.

FIG. 8A is a partially exploded perspective view of another example of a connector.

FIG. 8B is a perspective view of the connector used in FIG. 8A.

FIG. 8C is another view of the connectors and panel components of FIG. 8A.

FIG. 8D is an underside view of the connector panel.

Corresponding reference numerals indicate corresponding parts throughout the several views of the drawings.

### DETAILED DESCRIPTION

Example embodiments will now be described more fully with reference to the accompanying drawings.

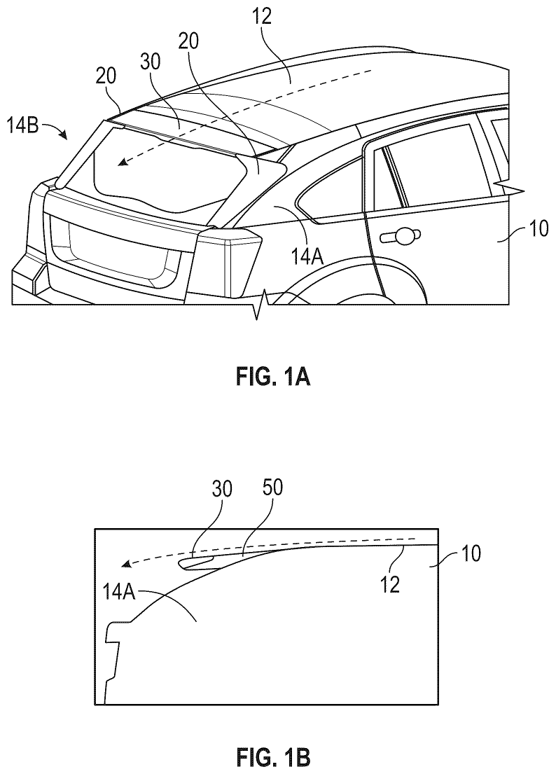

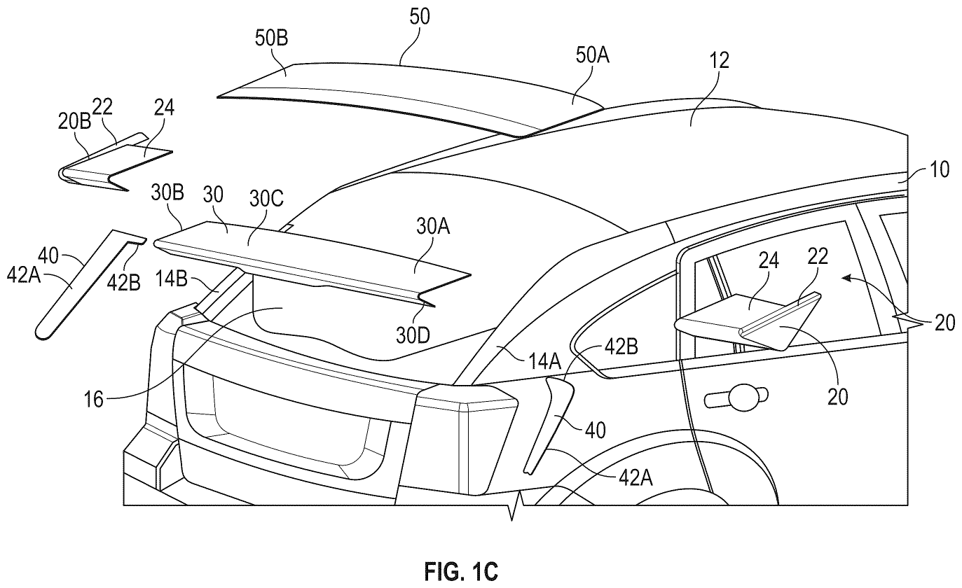

Referring now to FIGS. 1A, 1B and 1C, a vehicle 10 has a roof 12, a first rear pillar 14A and a second rear pillar 14B. The rear pillars 14A, 14B are spaced apart laterally on opposite sides of the vehicle 10 and are generally disposed in a vertical direction. The roof 12 may be referred to as a roof panel that extends laterally across the vehicle and longitudinally above the passenger compartment and/or the cargo area of the vehicle 10. A plurality of modular aerodynamic panels or components is provided on the vehicle 10. In the present example, six modular aerodynamic components are coupled to the rear pillars 14A, 14B, a greater number or lesser number of panels may be provided. In FIGS. 1A-1C, a pair of winglets 20 are coupled to the rear pillars 14A, 14B. The winglets 20 are mirror images of each other and are therefore referred to collectively. Each winglet has a mounting portion 22 that has reversible clips that couple the mounting portion 22 to the respective rear pillars 14A, 14B. This will be described in greater detail below. The mounting portions 22 have a laterally extending portion 24 that extends laterally partially across the rear portion of the vehicle 10. A wing 30 is coupled between the winglets 20 and more specifically between the mounting portions 24 of each winglet 20. The wing 30 may be fixedly coupled to the mounting portions 24 of the winglets 20. However, the wing 30 may also be rotatably mounted to the winglets 20. The wing 30 may be various shapes including various aerodynamic shapes. The wing 30 may have a top surface 30C and a lower surface 30D. Both the top surface 30C and the lower surface 30D may be coupled to the mounting portions 24 depending upon the configuration. An appliqué 40 may be located on each side of the vehicle. The appliqué 40 may be various shapes including elongated. The appliqués 40 may be coupled to the rear pillars 14A, 14B. The appliqués 40 on each side of the vehicle 10 may be mirror images of each other. The appliqués 40 may include a first portion 42A that are coupled to the pillars 14A, 14B, respectively. Removal and reversible fasteners or clips may used to couple the first portions 42A to the respective pillars 14A, 14B. The appliqués 40 may be various shapes and may have a laterally extending portion 42B.

A panel 50 extends between the roof 12 and the wing 30 to cover the opening 32 therebetween. The panel 50 has a first end 50A and a second end 50B. The ends 50A, 50B are coupled to the pillars 14A, 14B, respectively. As mentioned before, the wing 30 may have a space between the rear glass 16 and the roof 12 so that air may flow through when the panel 50 is not installed. When the panel 50 is installed, air flows over the roof panel and the wing 30 as illustrated in FIG. 1B. The panel 50 may be removable and replaceable by the use of removable clips or retainers as will be described in greater detail below. All or some of the components 20, 30, 40 and 50 may be used together or alone.

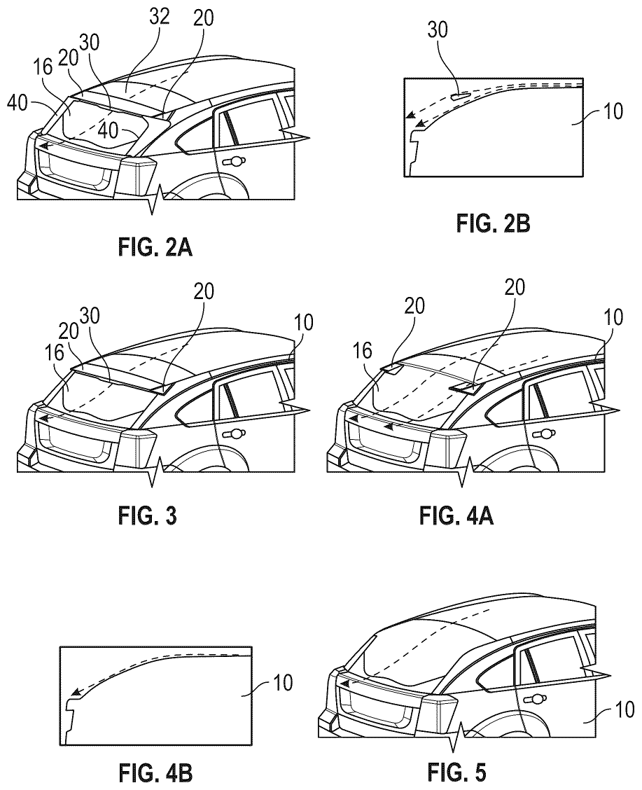

Referring now to FIGS. 2A and 2B, the vehicle 10 is illustrated having the panel 50 removed. In this example, the appliqués 40, the winglets 20 and the wing 30 are all provided. As is best shown in FIG. 2B, the airflow relative to the vehicle 10 is both above the wing 30 and below the wing 30.

Referring now to FIG. 3, a similar configuration that is illustrated in FIGS. 2A and 2B is set forth, however, the appliqués 40 have been removed so that only the wing 30 and the winglets 20 are provided. No roof panel is set forth and the airflow is the same as that illustrated in FIGS. 2A and 2B.

Referring now to FIGS. 4A and 4B, only the winglets are coupled to the rear pillars 14A, 14B. The airflow over the rear of the vehicle 10 is illustrated in FIG. 4B.

Referring now to FIG. 5, all of the aerodynamic removal panels have been removed and airflow is the same as that illustrated in FIG. 4B.

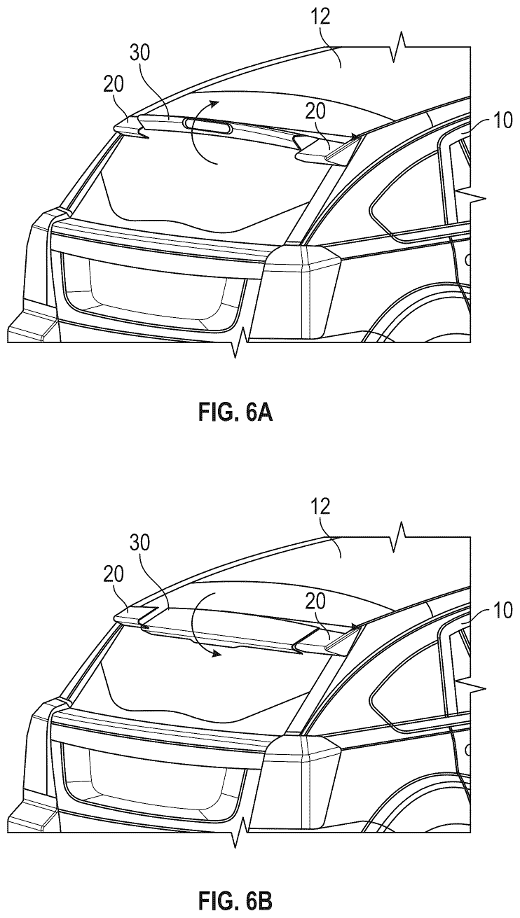

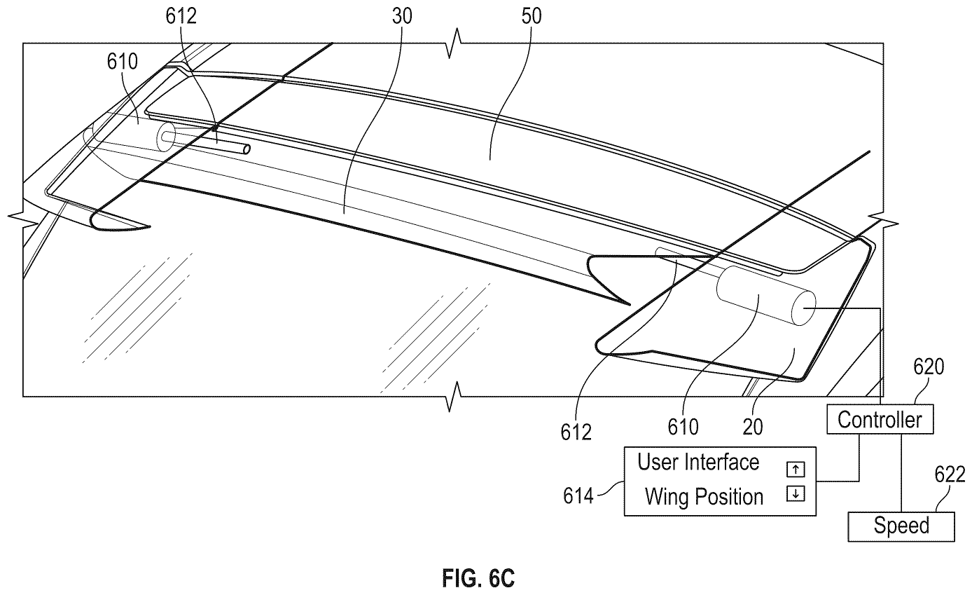

Referring now to FIGS. 6A and 6B, the wing 30 may be rotatably coupled to the winglets 20. In FIG. 6A, the wing 30 is illustrated in an upward position to allow the wing 30 to produce a high down force on the rear of the vehicle. In FIG. 6B, the wing 30 is illustrated in a lowered or downward position. That is, the wing 30 is rotated downward and may be used for preventing rear glass soiling while driving. Airflow in both FIGS. 6A and 6B are above and below the wing 30.

Referring now to FIG. 6C, the winglets 20 may include a motor 610 therein. The motor 610 has a shaft 612 that extends into and is coupled to the wing 30 so that wing 30 rotatable coupled to the winglets 20. In this example, the two motors 610 are illustrated in each winglet 20 on each side of the vehicle. A user interface 614 is illustrated. The user interface 614 may be used to select the wing position. A controller 620 may receive an input signal from the user interface 614 corresponding to the user position (a user position signal). The controller 620 controls the motor to position the wing 30 into the position set forth by the user interface 614. However, the controller 620 may also be used to automatically control the position of the wing 30. A speed sensor 622, in communication with the controller 620, may change the position of the wing 30 based upon the speed of the vehicle. That is, a speed signal 622 may be generated and communicated to the controller 620 that is used to control the position of the motor 610. The position may be desired to be automatically set such as when the vehicle 10 is operating at a speed above a predetermined speed threshold. For example, additional down force may be provided by the wing 30 above the predetermined speed.

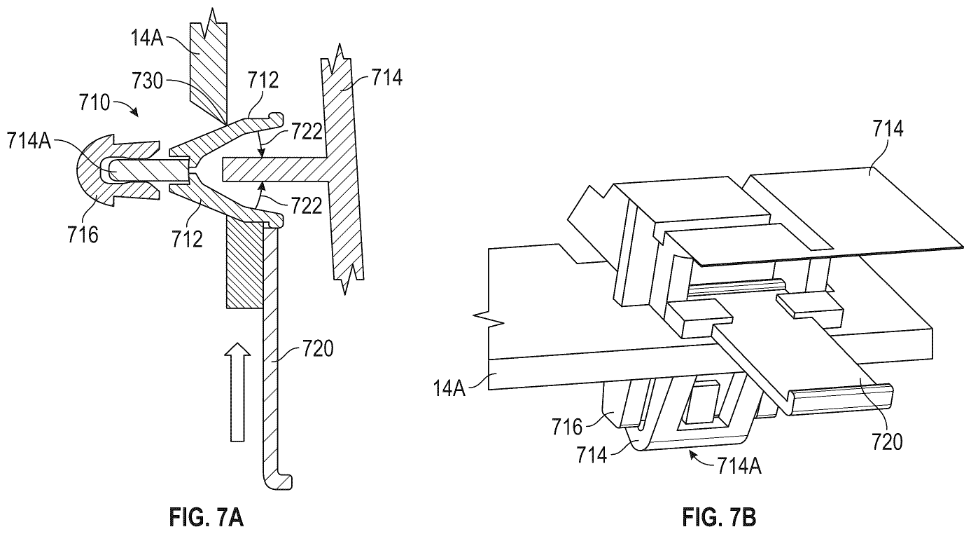

Referring now to FIGS. 7A and 7B, a cross section and perspective view of a releasable lever-actuated spring clip 710 is illustrated. In this example, spring arms 712 are used to receive a portion of a modular component 714. The modular component 714 may be one of the components 20, 30, 40 or 50 above. In this example, the spring arms 712 is fixed within the vehicle and has receiver 716. A lever 720 may be used to move the spring arms 712 into a released position as indicated by the arrows 722. The lever 20 may be fixed as part of the vehicle on the pillar 14A. A clip 714A may be formed as part of the component 714 and is received within the opening 730 and is retained by the receiver 716. The component 714 may be easily connected and disconnected from the vehicle for customization.

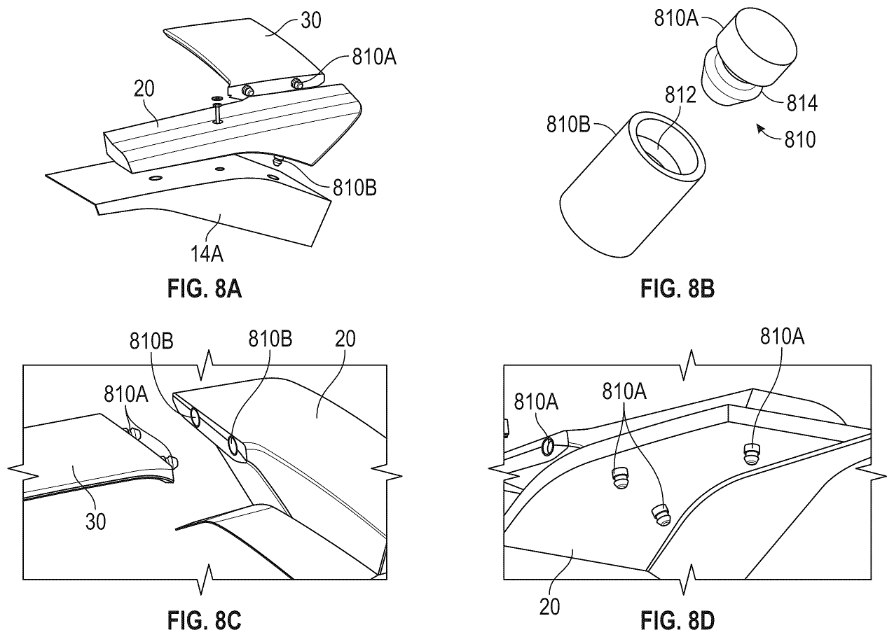

Referring now to FIGS. 8A-8D, another example of a connector 810 is illustrated. An extension portion 810A is received within a receiver 810B. In the example set forth in FIG. 8A, the winglet 20 is illustrated relative to the wing 30. The wing 30, in this example, is fixed into a position and is not rotatable. The inside of the receiver 810B may have a detent 812 for receiving a groove 814 in the extension 810A. In FIG. 8D, the underside of the winglet 20 is illustrated having a plurality of extensions 810A that are received within receivers.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. 1steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A vehicle comprising:
a first rear pillar;
a second rear pillar
a first winglet removably coupled to the first rear pillar;
a second winglet removably coupled to the second rear pillar; and
a wing having a first end coupled to the first winglet and a second end coupled to the second winglet.

2. The vehicle of claim 1 further comprising a first pillar appliqué removably coupled to the first rear pillar and a second pillar appliqué removable coupled the second rear pillar.

3. The vehicle of claim 2 wherein the first pillar appliqué is positioned below the first winglet and the second pillar appliqué is positioned below the second winglet.

4. The vehicle of claim 2 wherein the wing is removably coupled to the first winglet and the second winglet.

5. The vehicle of claim 2 wherein the wing is rotatably coupled to the first winglet and second winglet.

6. The vehicle of claim 5 wherein the first winglet or the second winglet comprises a motor operatively coupled to rotate the wing.

7. The vehicle of claim 6 wherein the motor is coupled to a user interface generating a position signal for positioning the wing.

8. The vehicle of claim 6 wherein the motor is coupled to a controller and a speed sensor, the wing is rotatably positioned in response to the speed sensor.

9. The vehicle of claim 8 wherein the wing is rotated in an upward position when a speed is above speed threshold.

10. The vehicle of claim 5 wherein the first winglet comprises a first motor comprising operatively coupled to rotate the wing and the second winglet comprises a second motor operatively coupled to rotate the wing.

11. The vehicle of claim 1 further comprising a panel extending across the vehicle coupled adjacent to the wing.

12. The vehicle of claim 11 wherein the panel is removably coupled to the first rear pillar and the second rear pillar.

13. The vehicle of claim 11 wherein the panel is removably coupled to the first rear pillar and the second rear pillar by reversible fasteners.

14. The vehicle of claim 11 wherein the panel is coupled over an opening between the wing and a roof.

15. The vehicle of claim 1 wherein the first winglet comprises a first mounting portion and a first laterally extending portion and the second winglet comprises a second laterally extending portion.

16. The vehicle of claim 15 wherein wing is coupled between the first laterally extending portion and the second laterally extending portion.

17. The vehicle of claim 1 further comprising reversible fasteners coupling the first winglet and the second winglet to the first rear pillar and the second rear pillar.

18. The vehicle of claim 17 wherein the reversible fasteners comprise push clips.

19. The vehicle of claim 18 wherein the reversible fasteners comprise lever actuated clips.

20. The vehicle of claim 1 further comprising further comprising a first pillar appliqué removably coupled to the first rear pillar and a second pillar appliqué removable coupled the second rear pillar, the vehicle further comprising a panel removably coupled to the first rear pillar and the second rear pillar over and opening between the wing and a roof.
